(19) United States
(12) Patent Application Publication
(10) Pub. No.: US 2026/0065190 A1
(43) Pub. Date: Mar. 5, 2026

(54) MAXIMIZE OCEAN UTILIZATION BY OPTIMIZING DIFFERENTIATED SAFETY STOCK FOR REPLENISHMENT THROUGH MULTIPLE MODES OF TRANSPORT

(71) Applicant: Dell Products L.P., Round Rock, TX (US)

(72) Inventors: Ravikant Sharma, Bangalore (IN); Shuang Shuang, Singapore (SG); Francisco Luis Erize, Alpharetta, GA (US); Venkatesh Gupta Gajawada, Singapore (SG)

(21) Appl. No.: 18/826,013

(22) Filed: Sep. 5, 2024

(51) Int. Cl. G06Q 10/0631

(52) U.S. Cl. CPC G06Q 10/06315

(57) ABSTRACT

One example method includes receiving input data and parameters, performing an FGA (finished goods assembly) replenishment simulation process using the input data and parameters, and outputs of the FGA replenishment simulation comprise a first safety DSI for a first transport mode, and a second safety DSI for a second transport mode, and the first transport mode is slower, and less expensive, than the second transport mode, and performing an FGA replenishment optimization process using the first safety DSI and the second safety DSI, and the FGA replenishment optimization process maximizes utilization of the first transport mode while satisfying one or more constraints.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Example embodiments disclosed herein generally relate to inventory and supply chain management. More particularly, at least some embodiments relate to systems, hardware, software, computer-readable media, and methods, for managing inventory and product replenishment using multiple different transportation modes that have different respective lead times.

### BACKGROUND

For consumers, an important factor regarding their purchasing decision is quick delivery time. To ensure this, it is vital that a company has inventory available at nearby hubs. However, holding large amounts of inventory has a cost that cannot be discounted. Since forecasts are not 100% accurate, the company needs a way to account for deviations in expected consumer demand for its product(s). That is, the company must strike a balance between (1) losing customers due to inventory stockouts, and (2) holding excess inventory leading to excessive carrying costs and/or material becoming obsolete due to overly long retention time in inventory.

A simplified version of the above scenario can be solved using basic linear optimization, but in reality, many supply chains are too complicated for such a relatively simplistic approach. For a company such as Dell, for example, the optimal DSI (days of sales inventory) cannot be easily calculated due at least in part to the complication that Dell, and other companies, have several options for inventory replenishment, each with its own cost per unit, and lead time for delivery.

Ocean mode, that is, transportation of goods by ship, is the cheaper option, but the lead time is quite long. If forecasts are lower than actual demand, ocean shipments cannot quickly replenish stock, and sales are likely to be lost as a result. Air mode, that is, transportation of goods by air, may act as a solution for this, having only half of ocean lead time typically, but air mode is much more costly than ocean mode. An optimal mix of the transportation modes is needed to maintain a balance of replenishment on-time, and cost incurred.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an FGA (Finished good Assembly) replenishment process, according to an embodiment.

FIG. 2 discloses a comparison between a comparative approach and an approach, according to one embodiment, for setting target inventory (DSI).

FIG. 3 discloses aspects of a comparative approach for inventory theory.

FIG. 4 discloses aspects, according to one embodiment, of sample outputs from Monte Carlo simulation for FGA replenishment.

FIG. 5 discloses a process of FGA replenishment optimization, according to one embodiment.

FIG. 6 discloses steps and decisions during each iteration of replenishment simulation, according to one embodiment.

FIG. 7 discloses sample output and formulas generated from optimization, according to one embodiment.

FIG. 8 discloses an example use case involving potential business value generated by an embodiment.

FIG. 9 discloses a service level example according to one embodiment.

FIG. 10 discloses a graph that represents the actual demand probability for a product forecasted to sell 700 units per week with an expected forecast accuracy of 85%, according to a use case for one embodiment.

FIG. 11 discloses an example algorithm for calculation of a fill rate, according to one embodiment.

FIG. 12 discloses an example safety stock calculation algorithm, according to one embodiment.

FIG. 13 discloses further information and algorithms for the example safety stock calculation algorithm of FIG. 12.

FIG. 14 discloses a numerical example concerning how to estimate a forecast error (MAPE), according to one embodiment.

FIG. 15 discloses an FGA replenishment Monte Carlo simulation according to one embodiment.

FIG. 16 discloses a graph of inventory level vs time, according to one embodiment.

FIG. 17 discloses an example computing entity configured and operable to perform any of the disclosed methods, processes, and operations.

### DETAILED DESCRIPTION OF SOME EXAMPLE EMBODIMENTS

Example embodiments disclosed herein generally relate to inventory and supply chain management. More particularly, at least some embodiments relate to systems, hardware, software, computer-readable media, and methods, for managing inventory and product replenishment using multiple different transportation modes that have different respective lead times.

Example embodiments include methods for providing an optimal ocean and air DSI, which may be refreshed weekly without human intervention. In this way, decisions may be taken as to the size of inventory for a product, and which transport mode(s), which may be bulk transport modes such as oceangoing ship, or cargo aircraft, should be used to convey the product. That is, an embodiment may identify an optimal mix of transportation modes needed to maintain a balance of replenishment on-time, and transportation cost incurred.

One such method may comprise performing a replenishment Monte Carlo simulation, and then, based on an outcome of the replenishment Monte Carlo simulation, performing a product inventory replenishment optimization process. The objective of such a method may be to maximize the usage of one transport mode, such as ocean for example, while satisfying various constraints, such as maintaining an average service at or above a specified threshold, and ensuring that an inventory target for a particular timeframe does not exceed an identified target level.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that the use of multiple, possibly concurrent, different transport modes for goods, each of the transport mode having a different associated cost, may be optimized according to various specified constraints. An embodiment may account for demand uncertainty when determining the extent to which different transport modes may, or will, be employed. An embodiment may incorporate risk management considerations and processes in the application of optimization constraints. Various other advantages of one or more example embodiments will be apparent from this disclosure.

### A. Glossary of Terms

Reference is made herein to various terms, some of which are listed below.

| Term | Definition |
|---|---|
| DSI | Days of sales inventory |
| MPP | Material production Plan |
| BTS | Build to Stock |
| FGA | Finished Goods Assembly |
| ODM | Original Design Manufacturer |
| PSI | Planning Sales Inventory |
| Ocean Attainment/ | Percentage of ocean purchase orders |
| Ocean utilization | over total purchase orders |
| Total Fulfilment | Sum of inventory holding cost and |
| Cost | inbound cost |
| OH Inventory | On-hand (current) Inventory |
| PO | Purchase Order |
| EOQ | End of Quarter |

### B. Context for an Example Embodiment

The following discussion of an example context for an embodiment makes reference to Dell teams and processes. However, this is only for the purposes of illustration and comparison to an example embodiment, and is not intended to limit the scope of this disclosure, the claims, nor applicability of any embodiments, in any way.

By way of illustration, and for the purposes of providing a comparative example, the Dell FGA replenishment planning team initially employed an inventory theory approach that created a solid baseline for determining a replenishment strategy. However, the nature of the Build-To-Stock (BTS) fulfillment process, together with the complication of the post-pandemic transportation situation, makes it difficult for FGA replenishment planner to understand, analyze, and decide on, the best inventory policy, which yields high ocean attainment, or utilization, and low total fulfillment cost while maintaining a specific service level and end-of-quarter inventory targets.

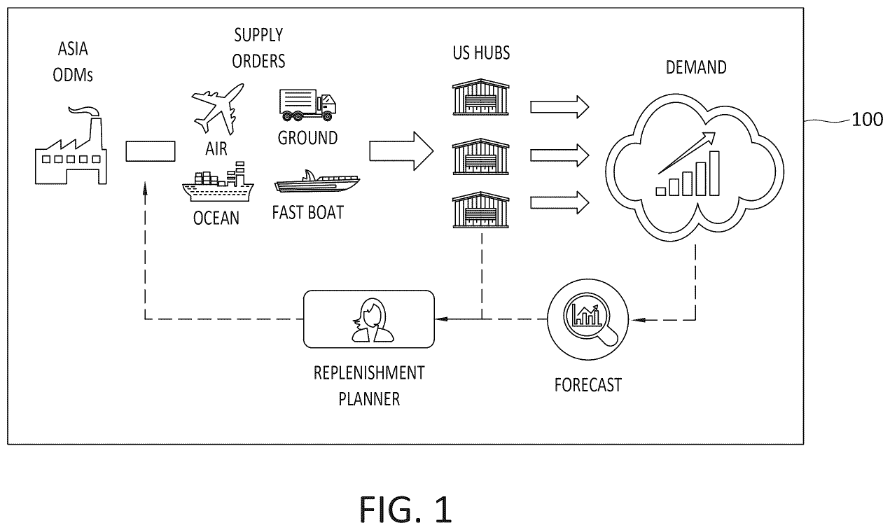

With attention now to FIG. 1, there is disclosed a comparative example of a FGA replenishment process 100. The BTS (built-to-stock) supply chain reflected in FIG. 1 can be problematic. In particular, since companies such as Dell moved to extended supply chains with ASIA ODMs, it has become common to utilize concurrent inbound logistics modes, a fast mode like air and a slow mode like ocean, in order to provide good service levels while maintaining lower levels of inventory. Notably however, this inventory theory approach was not configured to, and could not, consider multiple replenishment, or transport, modes, and thus was unable to provide the best policies, thereby resulting in a much lower utilization of ocean mode.

Thus, a planning team may not have working models or platforms that can effectively predict the performance of key indicators such as service level, inventory levels, and ocean vs air inbound utilization, under different conditions. Because of this shortcoming, these teams are not able to identify optimal policies except, possibly, by trial and error, which is very costly and time-consuming. Moreover, the business environment is subject to constant change, especially post-pandemic transportation modes and durations, so it is very difficult to analyze and test different inventory policies, as well as extract conclusions from previous year policies, making it hard for decision making for planners.

Finally, the linear optimization equations used in the comparative example of FIG. 1, to determine DSI, did not have the ability to determine an optimal proportion of air to ocean shipments, that is, and in contrast with an example embodiment, they were unable to optimize as among multiple different transport modes. At present, there is no mathematical equation known to the inventors to solve for the optimal proportion of different transport modes, such as air to ocean shipments for example. Additionally, a business may use one embodiment to establish business constraints in terms of confidence intervals, and in this way an embodiment may assign monetary values in cost savings to the risk analysis outputs, rather than simply defining risks qualitatively.

### C. Overview of Aspects of One Example Embodiment

### C.1 Introduction

As noted above, a comparative approach to one embodiment may address various considerations, such as how much DSI should be held to meet a given customer service level. Further, one consideration that may be addressed by an embodiment may be stated as “when replenishing inventory to meet a given customer service level, what proportion of that replenishment should come from an ocean transport mode, and what proportion of that replenishment should come from an air replenishment mode?” However, the comparative strategy does not consider what respective proportions of each shipping method should be used. That is, such strategy uses the common DSI targets for air and ocean decisions both set at <x> DSI. These shipments are thus not optimally scheduled to use air on an “as needed” basis, thereby increasing transportation costs.

As mentioned, the initial linear optimization equations used to determine target DSI do not have the ability to determine an optimal proportion of air to ocean shipments. That is, the inventors are unaware of any optimization scheme to solve, for example, for an optimal proportion of air to ocean shipments.

To address this shortcoming, an embodiment comprises a build out of a Monte Carlo simulation, shifting levers such as lead time and forecast accuracy to simulate air and ocean DSI scenarios. An embodiment may comprise an optimization algorithm that uses this simulation and find the optimal DSIs for both air and ocean transport modes so that ocean attainment, that is, use of the ocean transport mode, is maximized while maintaining one or more constraints, such as those related to service level and EOQ (end-of-quarter) inventory. When utilizing Monte Carlo simulation, an embodiment may base the optimization algorithm not only on standard expected value but may also conduct risk analysis by framing constraints on percentile outputs, and establish desired intervals of confidence.

### C.2 Discussion

To continue with the comparative Dell example, the Dell FGA replenishment process uses multiple transportation modes, such as ocean and air for example, with differing respective lead times. FGA replenishment planners were looking for a solution to optimize their planning strategy, with goals of increasing ocean attainment/utilization and thereby reduce total fulfillment cost given that ocean transport mode is cheaper than air. The comparative example of an inventory theory approach created a baseline for determining a replenishment strategy, but that approach could not consider multiple different transportation modes. Moreover, there was no tool that could effectively predict ocean utilization, or test different inventory policies to improve ocean utilization.

Given the shortcomings of the comparative example, an embodiment comprises a simulation approach that can handle multiple modes of transport such as, but not limited to, an ocean transport mode and an air transport mode, for optimal DSI policy setting and implementation. It is noted that while an example embodiment comprises the use of two different transport modes, the scope of this disclosure is not so limited and extends more broadly to two or more transport modes. Thus, an embodiment provides capabilities to planners to test and analyze different inventory policies, and to test and analyze various scenarios to improve ocean utilization and therefore help in reduction of total fulfillment costs. An embodiment may further comprise an inventory optimization through simulation to provide the optimal DSI for dual transport modes separately so that, for example, ocean utilization may be maximized while still maintaining one or more other constraints, such as the constraints related to service level, and EOQ inventory.

For running a simulation and optimization according to one embodiment, required input data was collected, such as relevant ODM and inventory hub locations, OH and current inventory, safety stock, lead times, sales forecasts, and historical sales data. After running an initial analysis using back-testing on optimization opportunity for 2 separate quarters for AMERICAS region, one embodiment indicated a potential increase of ^{˜}10% additional units shipped by ocean, which would result in a total savings opportunity of approximately $3 million/year in annual savings.

Thus, an embodiment implements setting up of optimal DSI for dual modes of transport concurrently, while considering constraints related to service level and EOQ inventory. An embodiment may be easily scaled to incorporate multiple transport modes and widely used in replenishment and inventory management use cases.

### D. Detailed Discussion of Aspects of One Example Embodiment

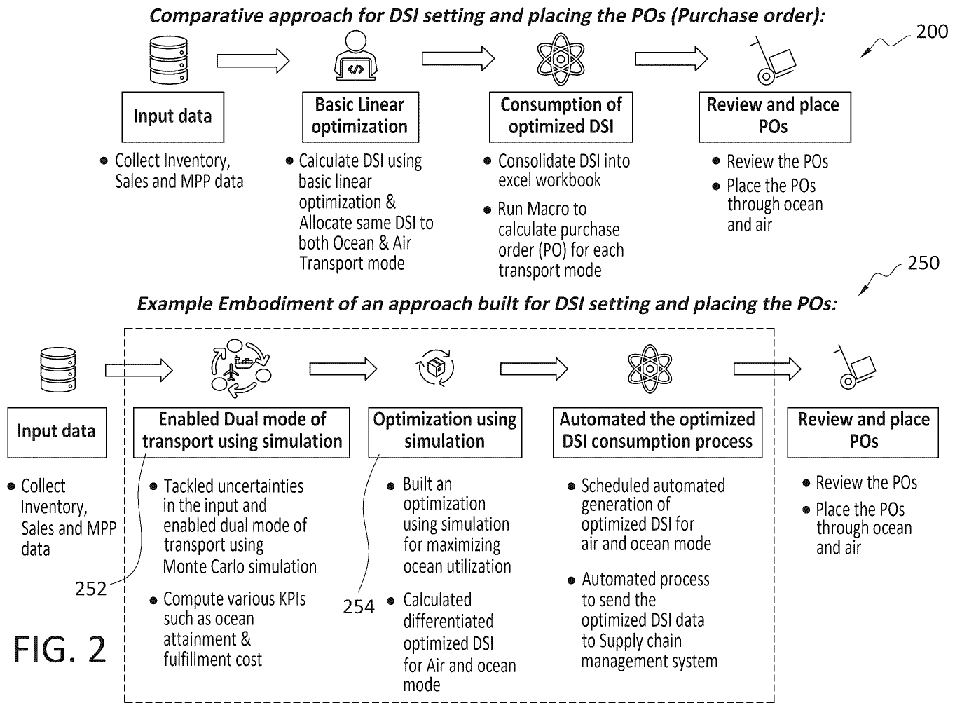

With reference next to FIG. 2, details are provided concerning a comparative example method 200 for setting target inventory (DSI) as it compares with an example method 250 for setting target inventory (DSI) according to one embodiment.

### D.1 Comparative Example

The comparative example method 200 to calculate an optimal DSI may be summarized as follows:
(a) comparative approach employed inventory management theory and a more basic excel based simulation approach—however, DSI for ocean and air was fixed, meaning that the DSI would always be the same for both transportation modes;
(b) these DSI values were fetched into an Excel® workbook named PSI (Planning, Supply & Inventory) file, and a macro run to calculate the purchase orders (PO) for each transport mode for all the FGAs present in the PSI file; and
(c) planners review the POs generated for the FGAs and then place the POs for both the transport modes.

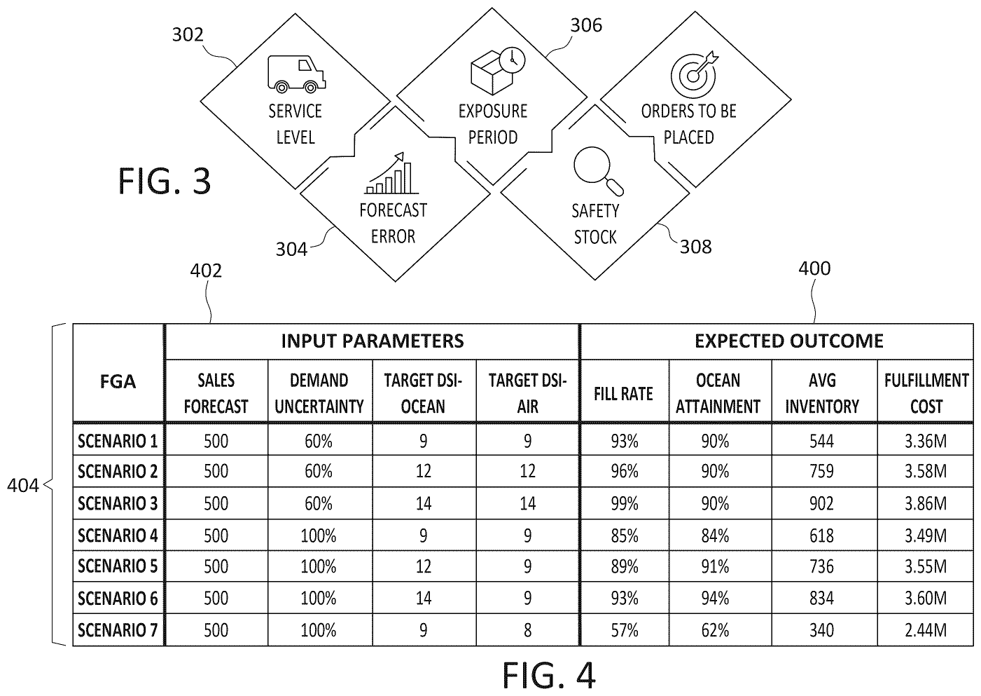

With reference next to FIG. 3, a comparative process 300 is disclosed for calculating target inventory using linear optimization. As discussed herein, some of the logic from this comparative process 300 may be incorporated in one embodiment.
(1) service level—a service level 302 is a percentage goal set to fulfil demand given normally distributed demand uncertainty—for example, a business may adopt the order fill rate metric (type-2) to track service level—further details about service level can be found in the Example 1 disclosed herein;
(2) forecast error—calculation of a forecast error 304 may involve taking, for example, the last 13 weeks of actual and last 13 weeks of forecast, which is lead time adjusted—after that, bias is removed from the forecast and forecast error (mean absolute percentage error) is calculated—a detailed example calculation for this is found in Example 3 disclosed herein;
(3) exposure period—calculation of an exposure period 306 may be performed on a periodic bass using the sum of the lead time required to correct shortages in the on-hand inventory position plus (+) the standard review period, thus:

$$exposure period = order review period + fulfillment lead time$$

(4) safety stock—once a service level metric and target are selected, they can be used to determine how many additional units of safety stock 308 should be held to avoid missed orders—further details about service level can be found in Example 2; and
(5) number of POs to be placed—that is, how many purchase orders (POs) will be placed for a given safety stock—in a periodic review approach, the projected on-hand inventory position is compared to the target inventory, which is calculated by adding the forecasted demand to the required safety stock, thus:

$$units {ordered}_{t} = {demand}_{t + L} + saftey stock - {( on hand inventory}_{t} + order {receipts}_{t + L} ) ,$$

$$where L = Lead time .$$

### D.2 Introduction

Referring again to the example of FIG. 2, instead of linear optimization as employed in the comparative method 200, the method 250 according to one embodiment utilizes digital simulation to simulate and optimize FGA DSI setting. It is integrated with supply chain planning system to automatically provide optimal ocean and air DSI, which refreshes weekly without human intervention. Even if there is any parameter change required due to business need, for example a decrease in EOQ inventory level, the whole process of configuring input parameters and obtaining the corresponding optimal DSI may take only a few minutes, in one embodiment, provided suitable computing power is available.

The example method 250 may comprise two components: 1) replenishment Monte Carlo simulation 252 and 2) replenishment optimization 254. This simulation 252 enables dual mode of transportation concurrently in a simulated replenishment process, and provides outcomes for different DSI policies, serving as the baseline engine for replenishment optimization 254. Replenishment optimization uses replenishment simulation to iterate through possible DSI policies and finally derives the optimal ocean and air DSIs for replenishment. It will be appreciated that a Monte Carlo simulation as employed in an embodiment cannot be practically performed as a mental process. See, for example, https://en.wikipedia.org/wiki/Monte_Carlo_method (incorporated herein in its entirety by this reference).

### D.3 FGA Replenishment Simulation (Monte Carlo)

Digital simulation is the process of inputting large amounts of data into a statistical model to perform a “what-if analysis” and re-create real world scenarios. It is a digital replica of the replenishment process, including all its dynamic rules, which makes it possible to replicate the behavior of the process automatically over time. Some examples of elements of an example embodiment simulation, exemplified at 250, but not included in the comparative inventory theory approach, exemplified at 200, are as follows:
(1) simulation takes two separate inventory targets for fast and slow mode of transport simultaneously, which has not been studied in any inventory management research or implemented in relative industry; and
(2) simulation replicates uncertainty in replenishment process.

In an embodiment, the FGA replenishment simulation enables different respective safety DSI values to be set for different modes of transport, for example, DSI_{slow} for slow mode and DSI_{fast} for fast mode, and separate target ending inventory or safety stock may be calculated based on DSI_{slow} and DSI_{fast}, respectively, using the formula below. By directly setting different respective safety stock values for each mode of transport, an embodiment enables easier control of the proportion of, for example, ocean transportation to air transportation used. Moreover, the FGA replenishment simulation according to one embodiment takes, as inputs, a dynamic lead time for multiple replenishment routes and transportation mode, making this FGA replenishment simulation more flexible and accurate in depicting a fast-changing logistic environment.

$$Safety {Stock}_{slow} = \frac{{\sum }_{t = slow lead time + 1}^{slow lead time + N} Sales {Forecast}_{t}}{( N * 7 ) * {DSI}_{slow}}$$

$$Safety {Stock}_{fast} = \frac{{\sum }_{t = fast lead time + 1}^{fast lead time + N} Sales {Forecast}_{t}}{( N * 7 ) * {DSI}_{fast}}$$

In the two equations immediately above, N is the number of weeks for which a forecast is generated on weekly basis. This number can be user defined, and, the value of N can vary between 1 and 52 weeks.

Further, in the presence of uncertainty, instead of returning a single prediction, an embodiment comprises a Monte Carlo simulation configured and operable to return a distribution of possible outcomes. With that distribution of outcomes, businesses can make informed decisions that consider the inherent uncertainties that are present in replenishment process. Detailed operations of a Monte Carlo simulation according to one embodiment can be found in the Example 4 disclosed herein.

In addition, running the Monte Carlo simulation according to one embodiment may enable planners to test different variations of a core inventory policy through different scenarios by updating the input parameters such as, for example, safety DSI, and lead time. With reference now to the example of FIG. 4, there are disclosed sample outputs 400 from a Monte Carlo simulation for FGA replenishment, according to one embodiment. Each of the sample outputs 400, or outcomes, corresponds to a respective set of input parameters 402 associated with a particular scenario 404. As shown in FIG. 4, planners can easily decide on a best inventory policy to implement by viewing and comparing, at one glance and in one place, all the outcomes 400 from different scenarios 404, where such outcomes 404 may include, but are not limited to service level or fill rate, ocean attainment, average inventory, and fulfilment cost.

### D.4 FGA Replenishment Optimization Using Simulation

A typical optimization algorithm does not work due to the two variables that are not within control but still affect outcomes, namely, forecast accuracy and forecast bias. With replenishment Monte Carlo simulation as base engine, a replenishment optimization according to one embodiment handles both demand uncertainty, as well as risk analysis, in optimization. While it may be cost effective to use ocean replenishment, planners must meet expected service level and maintain reasonable inventory level in order to meet customer expectation but without keeping excessive inventory. By applying risk management into optimization, an embodiment may use a confidence level indicator to define for this reasonable inventory level so that the probability of exceeding the inventory target is controlled within 1−Confidence Level.

Based on this, an embodiment employs an objective function, as shown below, and constraints, and implements the following replenishment optimization. In particular:

### (A) Objective Function:

The objective of optimization, in one embodiment, is to maximize the ocean utilization.

### (B) Constraints, According to One Embodiment:

(1) the average service level (over the period) must be 95%; and
(2) the inventory position at the end of the quarter cannot exceed a target (maximum inventory) defined by the user at given confidence level.

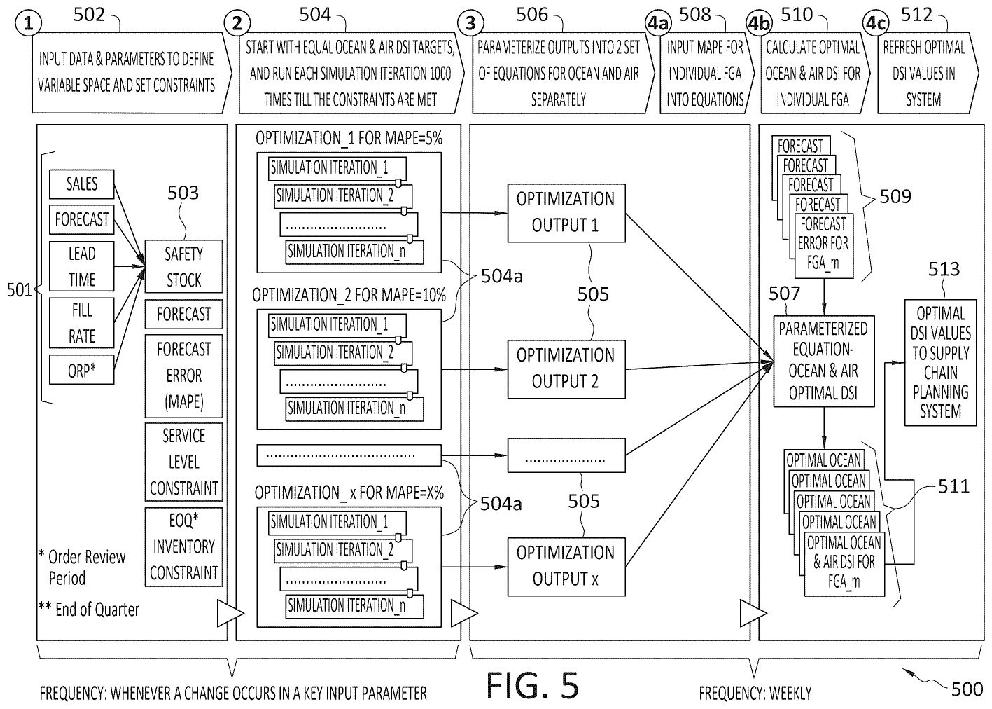

With attention now to FIG. 5, details are provided concerning an example method 500 for FGA replenishment optimization. In particular, the method 500 utilizes input data and user-defined parameters, such as forecast error, lead time and standard service level (95%), to define the variable space by calculating safety stock and optimal DSI for one mode of transport only.

Input data such as actual sales, demand forecast, lead time and forecast errors are collected and then calculated through the use of fully automated scheduled jobs. Users may provide the input parameters, such as service level and maximum EOQ inventory target, to optimization through a user interface (UI). These input parameters may, in one embodiment, be kept unchanged unless there are requirement or market change from business that dictate a change to the input parameters.

The FGA replenishment optimization method 500 assigns this calculated DSI to both ocean and air transport modes, and initiates different iterations of replenishment simulation. For each iteration of replenishment simulation, 1000 simulations are run. The FGA replenishment optimization method 500 then obtains the distribution of simulation outcomes and calculates the two constraints: (1) expected service level (95%); and (2) end of quarter (EOQ) inventory level at 95^{th} percentile.

In more detail, and with continued reference to the example of FIG. 5, the FGA replenishment optimization 500 may proceed as follows. Initially (1), input data and parameters 501 may be received 502 that are used to define a variable space and set constraints for the optimization, such as by calculating safety stock 503 and optimal DSI for one mode of transport only. The calculated DSI value may be assigned 504 to both ocean and air transport modes, and different iterations of replenishment simulation initiated where, in one embodiment, for each iteration of replenishment simulation, N (user defined number, generally >=1000 to get better estimates) simulations are run, possibly until the specified constraints are met.

As part of 504, various optimizations 504a may be run for different respective MAPE values to generate respective optimization outputs 505. These optimization outputs 505 may then be parameterized 506 into two sets of equations 507 for, respectively, the ocean mode and the air mode. Next, respective forecast errors (MAPE) 509 for each FGA simulation iteration may be input 508 into the sets of equations 507, where the equations 507 comprise parameterized equations for determining respective ocean, and air, optimal DSIs. Note that MAPE (mean absolute percentage error) may be determined as follows:

$$MAPE = ( 1 / n ) * \sum ( \vert actual - forecast \vert / \vert actual \vert ) * 10 \; 0 .$$

The equations 507 may then calculate 510 and output optimal ocean and air, respectively, DSIs 511 for each FGA simulation iteration. Finally, the optimal DSI values 511 are output 512 to a supply chain planning system 513 on a weekly basis.

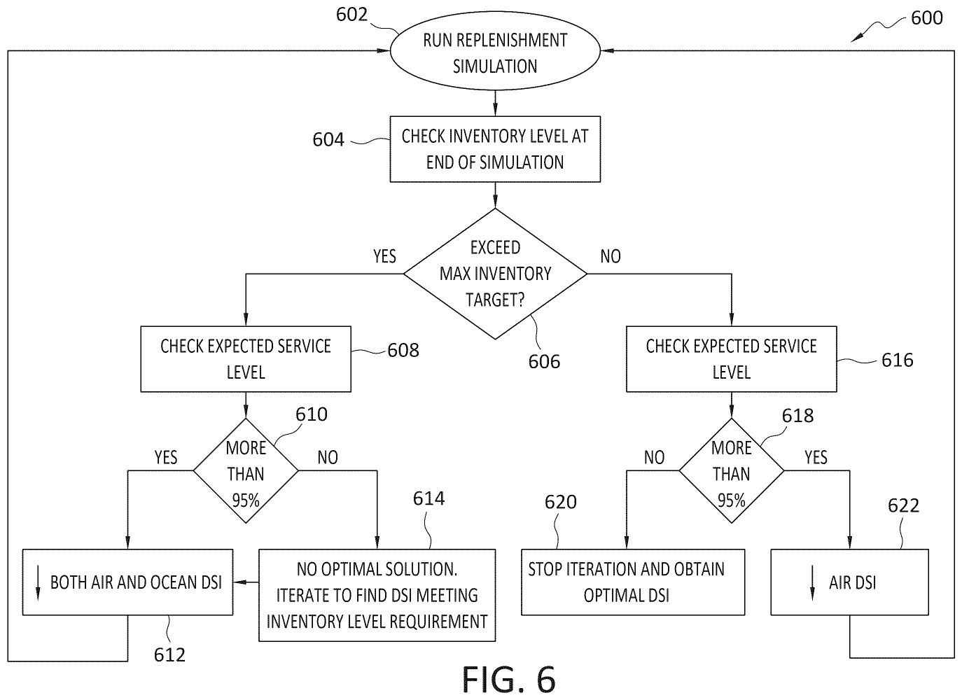

With reference now to FIG. 6, an example process 600 is disclosed that comprises operations for each iteration of an FGA simulation iteration (see reference 504 in FIG. 5). After completion 602 of an iteration of the replenishment simulation, a check 604 of the inventory level may be performed. If it is determined 606 that the maximum inventory target has been exceeded, the expected service level may be checked 608, and a determination 610 made as to whether the service level meets or exceeds 95%. If so, the air and ocean DSIs may then be decreased 612 and used as inputs to another iteration of the replenishment simulation 602. On the other hand, if it is determined 610 that the expected service level is not met, it may be deemed 614 that there is no optimal solution, after which the method 600 may advance to 612.

Returning to the determination 606, if the maximum inventory target has not been exceeded, a check 616 of the expected service level may be performed. If it is determined 618 that the service level does not meet or exceed 95%, the iteration may be stopped 620 and an optimal DSI obtained for both air and ocean transport modes. On the other hand, if the service level is determined 618 to meet or exceed 95%, the DSI for the air transport mode may be decreased 622, while the DSI for the ocean transport mode is kept constant, and the method 600 may return to 602.

With continued reference to the example of FIG. 6, various observations may be made. First, if both EOQ inventory and the service level constraint fails, the optimization will conclude there is no optimal solution, but will still iterate through replenishment simulation to find the DSI targets that meeting the EOQ target and show the user what is the best service level that the optimization can achieve.

Second, if the EOQ inventory constraint is not met but service level still above 95%, there is still chance to meet both constraints. The optimization will reduce air and ocean DSI concurrently to reduce inventory level. This operation was derived from experiments conducted by the inventors, who found that reducing the air DSI and the ocean DSI concurrently can reduce inventory level fast while do not depleting service level as quickly.

As a third observation with respect to the example of FIG. 6, once the inventory level constraint is met, the optimization switches to checking of the service level constraint. In an embodiment, a higher ocean DSI than air DSI results in higher inventory level with higher ocean attainment, and vice versa. To achieve the objective of maximizing ocean attainment, the optimization adjusts the parameter of replenishment simulation by keeping ocean DSI constant and decreasing air DSI. If service level is above 95%, it continues decreasing the air DSI and run replenishment simulation. Once the service level drops below 95%, the optimization stops the loop and concludes that the air DSI obtained in the previous iteration is optimal.

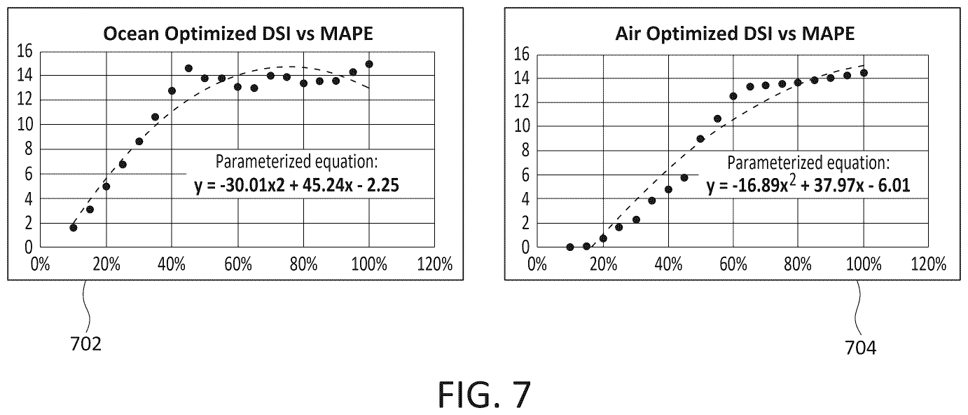

Fourth, after a list of optimal ocean and air DSI for different forecast error is derived, the optimization parameterizes them into formulas which, using a forecast error of an FGA, may be used to calculate optimal ocean and air DSIs. These parameterized formulas could be polynomial (of 1 or higher degrees), exponential, logarithmic equations or any other mathematical expressions used for parameterization. Examples of formulas that may be used in this regard are shown in FIG. 7. Namely, FIG. 7 discloses a graph 702 with ocean DSI optimized vs MAPE, and a graph 704 that shows air DSI optimized vs MAPE, thus:

$$Optimal Ocean DSI = a * Forecast {Error}^{2} + b * Forecast Error + c$$

$$Optimal Air DSI = m * Forecast {Error}^{2} + n * Forecast Error + p$$

That is, FIG. 7 discloses sample output and formulas generated from optimization.

As a final observation with respect to the example of FIG. 7, every week, an automated job may calculate forecast error (MAPE) for each individual FGA and input the MAPE values into the optimal DSI equations to calculate the differentiated ocean DSI and air DSI for an individual FGA. The optimal values may be fetched into supply chain planning system for planner review and action.

### D.5 Strategic and Business Value

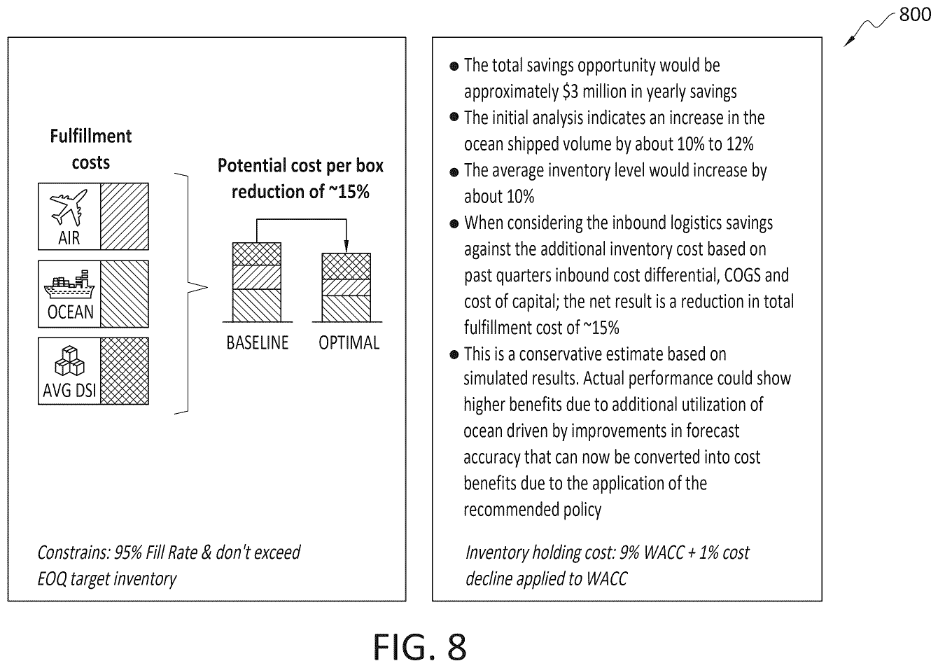

It will be appreciated that an embodiment may provide strategic and business value to an enterprise, at least by reducing inventory costs and/or transportation costs. For example, the inventors ran an initial analysis using back-testing on optimization opportunity for 2 separate quarters for the Americas region, and noted an increase of ^{˜}10% to 12% additional units shipped by ocean, resulting in potential reduction in the cost per box by ^{˜}15%. For the purposes of this example, this is projected to be approximately $3 million/year in annual savings. With expansion to other regions and other replenishment processes with multiple modes of transport, an embodiment may be expected to increase yearly savings even further. Further details concerning this initial analysis are disclosed in the example use case 800 disclosed in FIG. 8.

### E. Further Discussion

As disclosed herein, an embodiment may comprise various useful features and aspects, although no embodiment is required to possess any of such useful features and aspects. The following examples are illustrative, but not exhaustive.

### E.1 Concurrent Dual Mode of Transport

There is almost no research done in the field of inventory planning in which two, or more, fully concurrent inbound transportation modes are in use. At most, a few approaches have considered fulfilment models where a fast emergency replenishment mode can be used to supplement the main inbound mode, for example, emergency air shipment of inventory. Here, air shipment is used merely as an adjunct or fail-safe to a primary mode of transport, rather than being employed as a fully concurrent mode of transportation as in the case of one or more embodiments. An FGA replenishment simulation and optimization method according to one embodiment specifically employs a dual mode of transport and provides detailed answers including respective optimal proportions of air and ocean shipments during replenishment.

### E.2 Optimization Using Monte Carlo Simulation

Instead of an optimization algorithm such as employed in the comparative example disclosed herein, an FGA replenishment optimization approach according to one embodiment combines inventory management theory with Monte Carlo simulation to include demand uncertainty when solving for optimal DSIs for ocean and air transport modes. A similar optimization using simulation may be applied to other optimization problems containing the parameters/variables with uncertainties.

### E.3 Incorporate Risk Management in Optimization Constraints

While an approach such as that embodied in the comparative example disclosed herein, comprising a replenishment optimization algorithm, is based on objective functions and constraints that target expected values for key indicators. One embodiment employs risk management methodologies applied to stock portfolio risk management. An optimization algorithm according to one embodiment uses a standard objective function based on business targets but the constraints take the approach of targeting simulation distribution percentiles. This methodology of an embodiment provides the option for the business to establish Cis (confidence intervals) and directly map cost benefits to risk mitigation.

### F. Examples

Following is a discussion of various examples that illustrate one or more aspects of one or more embodiments. These examples are to be taken as illustrative only and are not limiting of the scope of the disclosure, or any claims, in any way.

### F.1 Example 1—Service Levels

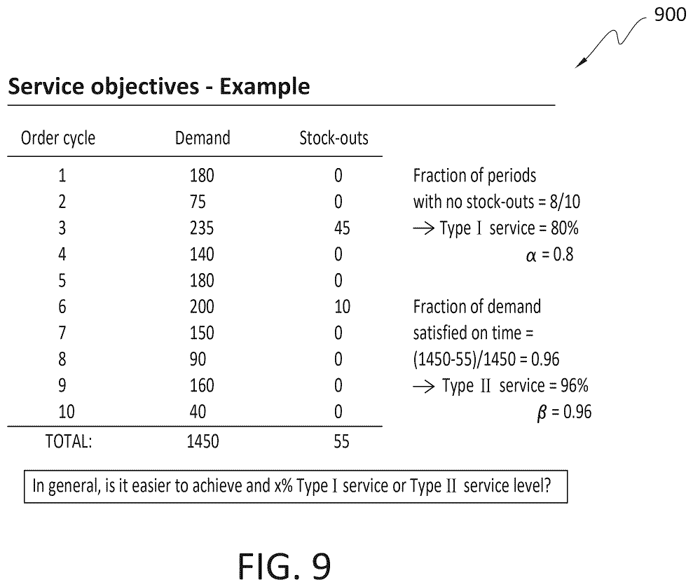

In an embodiment, there may be two types of service levels, example values for which are disclosed, or implied, in the table 900 of FIG. 9:
1. Type I Service Level: Also known as shelf availability, the probability that a business will not run out of stock during a replenishment cycle—Type I does not denote by how much the business will stock out (1 unit vs 100 units), but whether or not a stock out occurs; and
2. Type II Service Level: Also known as fill rate, the percentage of orders or units that are fulfilled from stock—for example, a service level of 95% implies that 95% of orders sold during the replenishment cycle were fulfilled from existing stock.

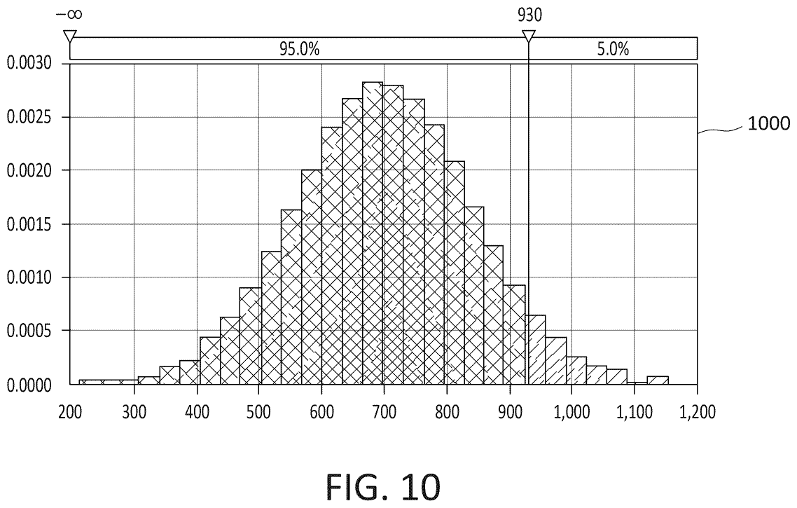

The graph 1000 disclosed in FIG. 10 illustrates an actual demand probability for a product forecasted to sell 700 units per week with an expected forecast accuracy of 85%. The forecast error is modeled by a normal distribution mathematically defined by the forecast accuracy. Type I service level in this example is 95%, which is the probability that a stock out will not occur. Type II service level, fill rate, in this example can be obtained through simulation or a unit loss table, being 99.6% in this case. This means 3 out of 700 orders will not be fulfilled from stock. The particular type of service level selected may depend on the particular needs and circumstances of business. For example, the Type II service level may be a better fit for a business that is more concerned with orders missed, than with whether or not a stockout occurred. This example has been referenced from “Inventory and Production Management in Supply Chains,” by Douglas Thomas, David Pyke, Edward Silver.

### F.2 Example 2—Fill Rate and Safety Stock

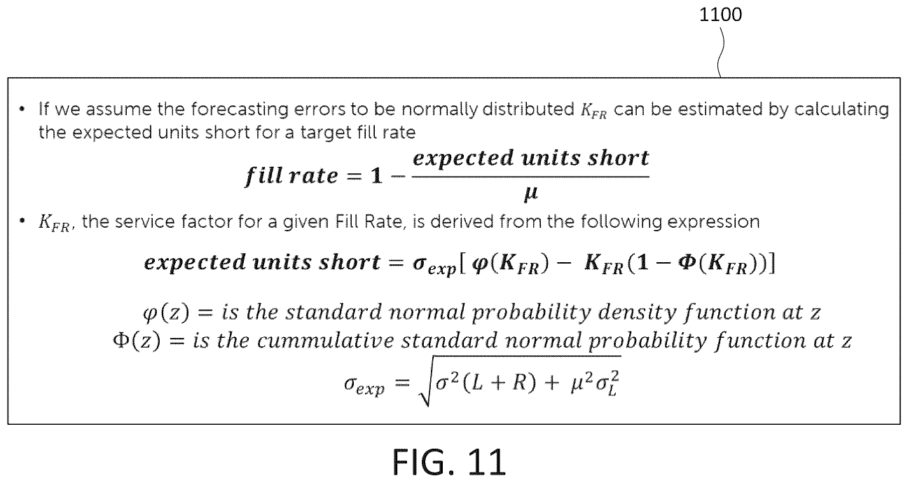

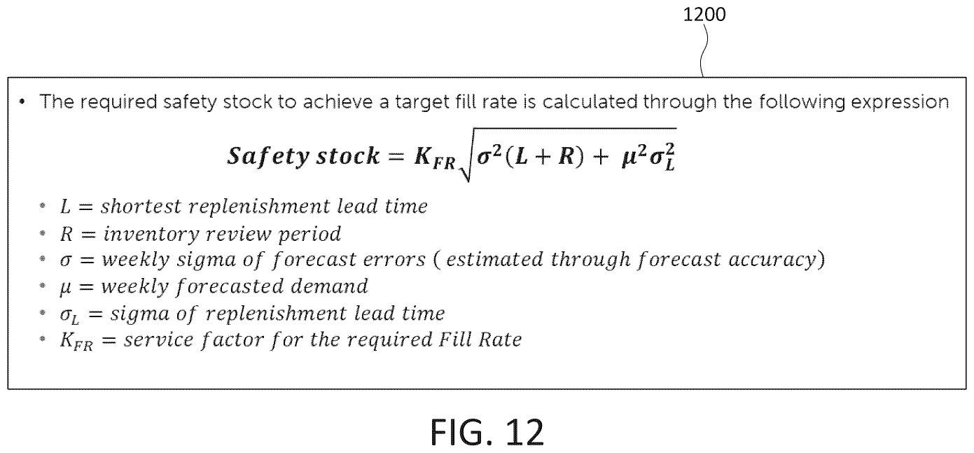

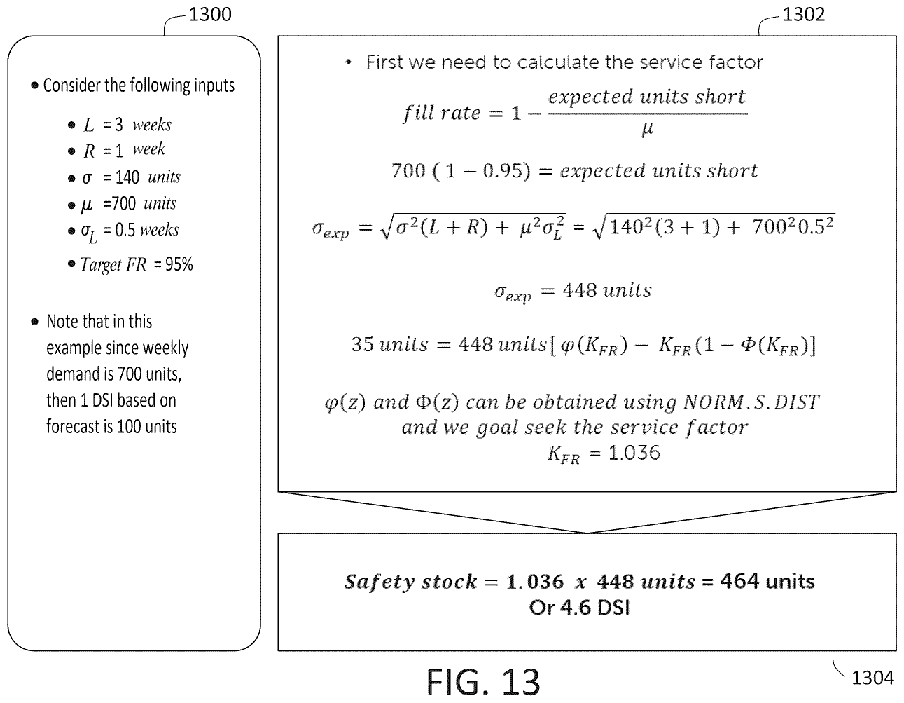

The following numerical example helps understand how to estimate fill rate (KFR) and safety stock. A fill rate may be calculated using the example algorithm 1100 disclosed in FIG. 11, where φ(z) and Φ(z) may be obtained using NORM.S.DIST and an embodiment may goal seek the service factor. The algorithm 1200 disclosed in FIG. 12 may be used calculate safety stock. FIG. 13 discloses an example use case in which various inputs 1300 are used in the calculation 1302 of safety stock 1304, using the algorithm 1200. See, for example, https://en.wikipedia.org/wiki/Safety_stock (incorporated herein in its entirety by this reference)

### F.3 Example 3—Forecast Error (MAPE)

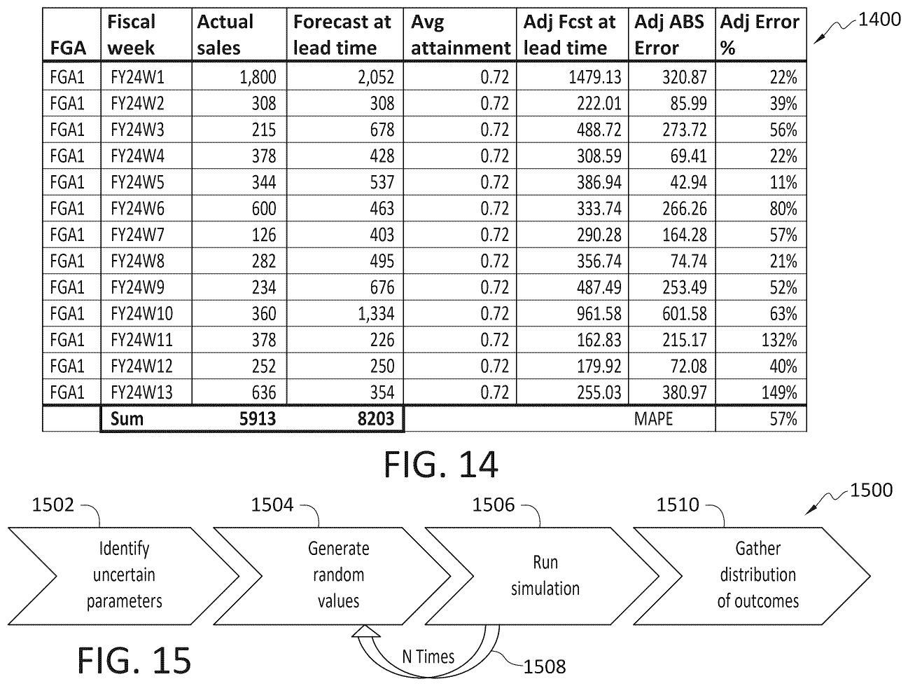

The numerical example 1400 disclosed in FIG. 14 helps to understand how to estimate the forecast error (MAPE). The numeric error values may be obtained using the MAPE equation disclosed elsewhere herein.

### F.4 Example 4—Monte Carlo Simulation

In an embodiment, a FGA replenishment Monte Carlo simulation works as shown in the example method 1500 disclosed in FIG. 15. The example method 1500 may begin with identification 1502 of the uncertain parameters in the replenishment process, that is, the demand and lead times. An embodiment may define the amount of uncertainty, in the form of probability distributions for each of these parameters based on historical demand and lead time.

Next, random values may be generated 1504 for each of the uncertainty parameters. The simulation may then be run 1506 using the randomly generated input values, and the corresponding outputs recorded. For example, a planner may wish to simulate changes in service level for a specific inventory policy based on the randomly generated 1504 demand values.

In an embodiment, the operations 1504 and 1506 may be repeated 1508 ‘N’ times, where ‘N’ refers to the sample size, to generate and gather 1510 a large number of possible outcome values. The larger sample size ‘N’ is, the better the method 1500 approximates reality. In an embodiment, a probability distribution of the output values may be analyzed to enable an understanding of the range of possible outcomes and their respective likelihoods.

### F.5 Example 5—OH Inventory

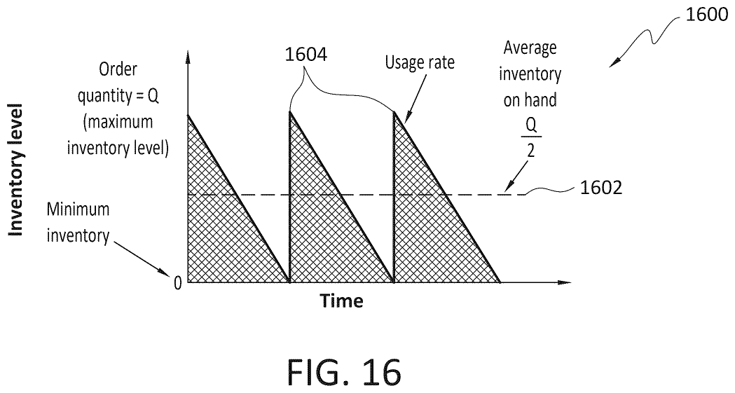

With reference to the graph 1600 disclosed in FIG. 16, and embodiment may define average OH inventory as follows:
as used herein, an AVG inventory refers to average over a period of time, which is not the same as, nor to be confused as, an average value obtained across multiple simulations; and
if inventory is measured just after receiving new product, and just before getting new product, then the average for a week is the mid point between those two observations—the average 1602 over several weeks is the average of that number; and
alternatively, an embodiment may simply measure the peak inventory position and simply communicate the average of those peaks 1604.

### G. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### H. Further Example Embodiments

Following are some further example embodiments. These are presented only by way of example and are not intended to limit the scope of this disclosure or the claims in any way.

Embodiment 1. A method for determining days of sales inventory (DSI), comprising: receiving input data and parameters; performing an FGA (finished goods assembly) replenishment simulation process using the input data and parameters, and outputs of the FGA replenishment simulation comprise a first safety DSI for a first transport mode, and a second safety DSI for a second transport mode, and the first transport mode is slower, and less expensive, than the second transport mode; and performing an FGA replenishment optimization process using the first safety DSI and the second safety DSI, and the FGA replenishment optimization process maximizes utilization of the first transport mode while satisfying one or more constraints.

Embodiment 2. The method as recited in any preceding embodiment, wherein the FGA replenishment optimization process comprises a Monte Carlo simulation.

Embodiment 3. The method as recited in any preceding embodiment, wherein the first transport mode is an ocean transport mode, and the second transport mode is an air transport mode.

Embodiment 4. The method as recited in any preceding embodiment, wherein the one or more constraints comprise an average service level over a defined period of time, and a maximum inventory level at an end of the period of time.

Embodiment 5. The method as recited in embodiment 4, wherein the maximum inventory level is defined by a user at a given confidence level.

Embodiment 6. The method as recited in any preceding embodiment, wherein performing the FGA replenishment optimization process comprises calculating a safety stock level for either the first transport mode or the second transport mode.

Embodiment 7. The method as recited in any preceding embodiment, wherein the FGA replenishment optimization process generates an optimal DSI for the first transport mode, and an optimal DSI for the second transport mode.

Embodiment 8. The method as recited in any preceding embodiment, wherein the FGA replenishment optimization process takes into account a demand uncertainty for the finished goods.

Embodiment 9. The method as recited in any preceding embodiment, wherein the FGA replenishment optimization process assumes that the first transport mode and the second transport mode are utilized simultaneously with each other.

Embodiment 10. The method as recited in any preceding embodiment, wherein the input data and parameters comprise any one or more of: ODM and inventory hub locations; OH and current inventory; safety stock; lead times; sales forecasts; and, historical sales data.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### I. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform anyone or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

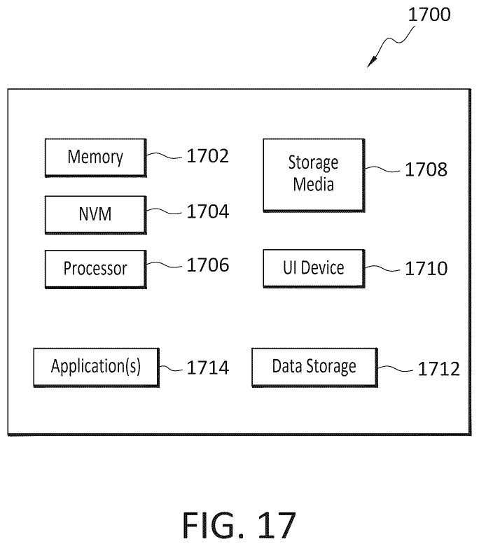

With reference briefly now to FIG. 17, any one or more of the entities disclosed, or implied, by FIGS. 1-16, and/or elsewhere herein, may take the form of, or include, or be implemented on, or hosted by, a physical computing device, one example of which is denoted at 1700. As well, where any of the aforementioned elements comprise or consist of a virtual machine (VM), that VM may constitute a virtualization of any combination of the physical components disclosed in FIG. 17.

In the example of FIG. 17, the physical computing device 1700 includes a memory 1702 which may include one, some, or all, of random access memory (RAM), non-volatile memory (NVM) 1704 such as NVRAM for example, read-only memory (ROM), and persistent memory, one or more hardware processors 1706, non-transitory storage media 1708, UI device 1710, and data storage 1712. One or more of the memory components 1702 of the physical computing device 1700 may take the form of solid state device (SSD) storage. As well, one or more applications 1714 may be provided that comprise instructions executable by one or more hardware processors 1706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

1. A method for determining days of sales inventory (DSI), comprising:
receiving input data and parameters including historical sales data and forecast error data;
performing an FGA (finished goods assembly) replenishment simulation process implemented on one or more processors and comprising a Monte Carlo simulation that executes a plurality of simulation iterations to generate a distribution of inventory outcomes using the input data and parameters, wherein the simulation concurrently models a first transport mode and a second transport mode having different lead times, and outputs of the FGA replenishment simulation comprise a first safety DSI for a first transport mode, and a second safety DSI for a second transport mode, and the first transport mode is slower, and less expensive, than the second transport mode;
performing an FGA replenishment optimization process using the first safety DSI and the second safety DSI, wherein the optimization process iteratively adjusts the first safety DSI and the second safety DSI across successive Monte Carlo simulation iterations, evaluates percentile values of the generated distribution of inventory outcomes, and the FGA replenishment optimization process maximizes utilization of the first transport mode by holding the first safety DSI constant while decreasing the second safety DSI until a service-level constraint fails, while satisfying one or more constraints defined at a user-specified confidence level;
generating, based on the optimized first and second safety DSI values, separate replenishment quantities for the first transportation mode and the second transportation mode.

2. The method as recited in claim 1, wherein the FGA replenishment optimization process comprises a Monte Carlo simulation.

3. The method as recited in claim 1, wherein the first transport mode is an ocean transport mode, and the second transport mode is an air transport mode.

4. The method as recited in claim 1, wherein the one or more constraints comprise an average service level over a defined period of time, or a maximum inventory level at an end of the period of time.

5. The method as recited in claim 4, wherein the maximum inventory level is defined by a user at a given confidence level.

6. The method as recited in claim 1, wherein performing the FGA replenishment optimization process comprises calculating a safety stock level for either the first transport mode or the second transport mode.

7. The method as recited in claim 1, wherein the FGA replenishment optimization process generates an optimal DSI for the first transport mode, and an optimal DSI for the second transport mode.

8. The method as recited in claim 1, wherein the FGA replenishment optimization process takes into account a demand uncertainty for the finished goods.

9. The method as recited in claim 1, wherein the FGA replenishment optimization process assumes that the first transport mode and the second transport mode are utilized simultaneously with each other.

10. The method as recited in claim 1, wherein the input data and parameters comprise any one or more of: ODM (Original Design Manufacturer) and inventory hub locations; OH (On-hand) and current inventory; safety stock; lead times; sales forecasts; and, historical sales data.

11. A non-transitory storage medium having stored therein instructions that are executable by one or more hardware processors to perform operations comprising:
receiving input data and parameters including historical sales data and forecast error data;
performing an FGA (finished goods assembly) replenishment simulation process implemented as a Monte Carlo simulation executing a plurality of simulation iterations to generate a distribution of inventory outcomes using the input data and parameters, wherein the simulation concurrently models a first transport mode and a second transport mode having different lead times, and outputs of the FGA replenishment simulation comprise a first safety DSI for a first transport mode, and a second safety DSI for a second transport mode, and the first transport mode is slower, and less expensive, than the second transport mode;
performing an FGA replenishment optimization process using the first safety DSI and the second safety DSI, and the FGA replenishment optimization process iteratively evaluates percentile values of the distribution of inventory outcomes and maximizes utilization of the first transport mode by asymmetrically adjusting the second safety DSI relative to the first safety DSI while enforcing user-defined confidence-level constraints;
generating, based on the optimized first and second safety DSI values, separate replenishment quantities for the first transportation mode and the second transportation mode.

12. The non-transitory storage medium as recited in claim 11, wherein the FGA replenishment optimization process comprises a Monte Carlo simulation.

13. The non-transitory storage medium as recited in claim 11, wherein the first transport mode is an ocean transport mode, and the second transport mode is an air transport mode.

14. The non-transitory storage medium as recited in claim 11, wherein the one or more constraints comprise an average service level over a defined period of time, or a maximum inventory level at an end of the period of time.

15. The non-transitory storage medium as recited in claim 14, wherein the maximum inventory level is defined by a user at a given confidence level.

16. The non-transitory storage medium as recited in claim 11, wherein performing the FGA replenishment optimization process comprises calculating a safety stock level for either the first transport mode or the second transport mode.

17. The non-transitory storage medium as recited in claim 11, wherein the FGA replenishment optimization process generates an optimal DSI for the first transport mode, and an optimal DSI for the second transport mode.

18. The non-transitory storage medium as recited in claim 11, wherein the FGA replenishment optimization process takes into account a demand uncertainty for the finished goods.

19. The non-transitory storage medium as recited in claim 11, wherein the FGA replenishment optimization process assumes that the first transport mode and the second transport mode are utilized simultaneously with each other.

20. The non-transitory storage medium as recited in claim 11, wherein the input data and parameters comprise any one or more of: ODM (Original Design Manufacturer) and inventory hub locations; OH (On-hand) and current inventory; safety stock; lead times; sales forecasts; and, historical sales data.
